(19) United States
(12) Patent Application Publication
(10) Pub. No.: US 2020/0001781 A1
(43) Pub. Date: Jan. 2, 2020

(54) Warning message system for deterrence of tailgating

(71) Applicant: Vernard Sanders, Houston, TX (US)

(72) Inventor: Vernard Sanders, Houston, TX (US)

(21) Appl. No.: 16/024,876

(22) Filed: Jul. 1, 2018

(51) Int. Cl. B60Q 1/50

(52) U.S. Cl. CPC B60Q 1/503; B60R 16/03

(57) ABSTRACT

The invention is directed to a warning message system for the deterrence of tailgating. The system provides one or more photoelectric sensors on the rear bumper of the user's vehicle, which determine the distance between the user's vehicle and any vehicle which may be following. The system then compares this distance to the speed of the user's vehicle to determine whether the driver of the following vehicle is allowing a safe stopping distance between vehicles. If it is determined that the driver of the following vehicle is tailgating, a large, red warning message is projected on the rear window of the user's vehicle and, if the following vehicle continues to tailgate for a predetermined period such as 2 seconds or more, a camera acquires an image of the following vehicle's license plate. The image, along with date, time, speed, distance, and location information, is then transmitted to the user's auto insurance company for further action.

### CROSS-REFERENCE TO RELATED APPLICATIONS

This application relates back to, and claims the priority of Provisional Patent Application No. 62/547,785 filed on Aug. 19, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle safety systems and accessories, and in particular to a warning message system for deterrence of tailgating. Millions of dollars in property damage, and thousands of deaths and injuries, are caused every year due to the practice of tailgating: a vehicle driver following another vehicle too closely, such that he cannot avoid a collision if the lead vehicle slows down or stops. Such safety devices as a third, elevated brake light have become mandated by law, but have unfortunately proven to have little effect on the number of rear-end collisions.

A search of the prior art reveals various devices which have been developed to provide the features of a message system mounted on a vehicle. In particular, none of the prior art devices provide deterrence for tailgating. None are closely related to the present invention, but several include features which resemble those of the present invention. Each has proven to be less than satisfactory for the present purpose in its own way.

Automobile window message display device, U.S. Pat. No. 6,446,375 (priority Jul. 14, 2000), provides a durable lightweight rigid transparent envelope which is slightly curved in shape from top to bottom and attaches to automobile windows via suction cups, in order to hold and display a variety of double-sided thin flexible lightweight message sheets, which are highly color-contrasted and light-reflective. The message sheets contain large font character size messages in order to facilitate visual communication between automobile operators, passengers and pedestrians at distances normally encountered on streets and highways. A selected message can be displayed in the envelope through the envelope's transparent front side when it is attached to the inside of an automobile window, or a selected message can be displayed through the envelope's transparent back side while the envelope is attached to the outside of an automobile window by the same means. Indentations at the top of the envelope provide for quick and easy removal of message sheets by grasping them with the tip of a thumb and finger of the hand Small notches at the top of the envelope provide for the attachment of elastic bands in order to hold the message sheets in place inside the envelope when laying flat while not in use or being stored.

Automotive message indicator, U.S. Pat. No. 3,226,707 (priority Jun. 20, 1963), provides an indicator for use in conjunction with an automotive vehicle; and further provides means whereby an operator of a vehicle may indicate to others any of a series of predetermined messages. While many varieties and types of such devices have been made available, there is still an area that has been left unsatisfied. It is often important for the operator of a vehicle to indicate to others certain messages. At present, a driver may signal only by utilizing hand signals, directional indicators, and brake lights. Other important conditions may not be indicated. For example, it is often desirable to indicate to another driver in the rear that he is tailgating or driving too close. At other times, it may be important to indicate to a driver in the rear some emergency condition ahead which might not be otherwise apparent or to warn of some emergency condition. Additionally, messages may be important while parked, such as Doctor on Call.

Vehicle message terminal, United Kingdom Patent No. 2256074A (priority Dec. 14, 1983), provides a vehicle message terminal comprising a car radio receiver incorporating separate receiving circuits for paging messages and public entertainment broadcasts. The receiver has a common antenna input for both circuits and a front panel incorporating conventional radio tuning scales and light emitting diode visual display for paging messages. The paging receiver is powered from the vehicle battery via the ignition switch.

Selectable message signalling system, United Kingdom Patent No. 2151380A (priority Jan. 16, 1991), provides a selectable message signalling system for use in the window of a vehicle and comprising: a screen; means for mounting the screen adjacent a window of the vehicle; a number of messages from which one or more may be selected for display on the screen; means on the screen for attracting attention; and means for removably mounting selected messages on the screen so that in operation the screen may be extended across a vehicle window and a suitable message mounted on the screen is visible to passing motorists.

Vehicle signaling system, U.S. Pat. No. 6,154,126 (priority Oct. 5, 1999), provides a communication system and a method for communicating simple coded messages from one vehicle to another. The communication system includes a signaling module that includes a light source configured and placed so that the light source is visible to occupants of other vehicles. The system includes a control module in communication with the signaling module that is readily accessible to the driver or other occupant of a vehicle. Responsive to the selection of one of a series of possible messages by the driver or occupant, the control module causes the light source to turn on and off in a predetermined sequence of flashes. The predetermined sequence of flashes represents a code corresponding to the selected message. The messages associated with use of the communication system are selected for enhancement of safety and to avert the negative responses associated with road rage.

Vehicle-mounted electronic display system, U.S. Pat. No. 5,132,666 (priority Sep. 17, 1990), provides a system for displaying information upon a vehicle. An electronic display is connected to a processor which generates character and graphics information. A power supply is connected to the electronic display and to the processor for providing operative power thereto. A programming device is connected to the processor for providing routines, which contain different messages for the electronic display. The screen of the display is mounted on the vehicle by means of an adjustably slidable mounting bracket. The display comprises a variable information section and a fixed information section. The fixed information section is mounted to the top of the variable information section.

An effective tailgating deterrence system, which presents a more visible warning to tailgating drivers and also provides an avenue for taking action against such drivers, would be very useful and would be well received. A warning message system for deterrence of tailgating, which displays a large, written warning message on the user's rear window and transmits a tailgating driver's license plate number to the user's auto insurance company for further action, would resolve this problem.

### SUMMARY OF THE INVENTION

Accordingly, the invention is directed to a warning message system for the deterrence of tailgating. The system provides one or more photoelectric sensors on the rear bumper of the user's vehicle, which determine the distance between the user's vehicle and any vehicle which may be following. The system then compares this distance to the speed of the user's vehicle to determine whether the driver of the following vehicle is allowing a safe stopping distance between vehicles. If it is determined that the driver of the following vehicle is tailgating, a large, red warning message is projected on the rear window of the user's vehicle and, if the following vehicle continues to tailgate for a predetermined period such as 2 seconds or more, a camera acquires an image of the following vehicle's license plate. The image, along with date, time, speed, distance, and location information, is then transmitted to the user's auto insurance company for further action.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a rear view of a vehicle with the first exemplary embodiment installed, displaying the photoelectric sensors 10, the vehicle 12, and the rear bumper 13.

FIG. 2 is a rear view of a vehicle with the first exemplary embodiment installed and a warning message displayed, displaying the photoelectric sensors 10, the warning message 11, the vehicle 12, the rear bumper 13, and the rear window 14.

FIG. 3 is a rear perspective view of a vehicle with the first exemplary embodiment installed and a warning message displayed, displaying the photoelectric sensors 10, the warning message 11, the vehicle 12, the rear bumper 13, and the rear window 14.

FIG. 4 and FIG. 5 are rear perspective close-up views of a photoelectric sensor of the first exemplary embodiment, displaying the photoelectric sensor 10, and the rear bumper 13.

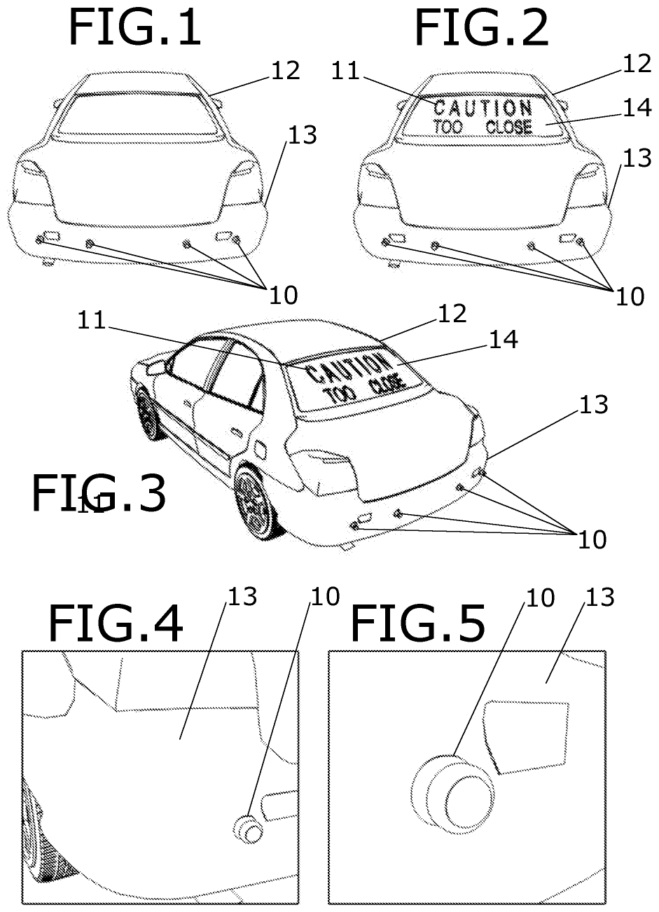

### DETAILED DESCRIPTION OF THE INVENTION

Referring now to the invention in more detail, the invention is directed to a warning message system for deterrence of tailgating.

It is intended for the invention to be installed as an after-market modification by the owner of a vehicle, or by an auto dealer or a repair or customizing shop. An alternate embodiment, intended for installation as original equipment by the vehicle manufacturer, is also contemplated.

The first exemplary embodiment is comprised of a control unit which provides electronic communication with the control system of the user's vehicle 12, including the speedometer and Global Positioning System (GPS) equipment of the vehicle. The control unit further provides electric power and electronic communication to a camera, one or more photoelectric sensors 10, and a projection unit. Preferably, the camera and the projection unit are to be installed on the rear deck of the passenger compartment of the vehicle 12, beneath the rear window 14, and the photoelectric sensors 10 are to be installed on the rear bumper 13 of the vehicle 12. Preferably, the control unit draws electric power from the electric system of the user's vehicle 12.

The photoelectric sensors 10 determine the distance between the user's vehicle 12 and any vehicle which may be following. The system then compares this distance to the speed of the user's vehicle 12, acquired from the speedometer, to determine whether the driver of the following vehicle is allowing a safe stopping distance between vehicles. If it is determined that the driver of the following vehicle is tailgating, a large, red warning message 11 is projected on the rear window 14 of the user's vehicle 12 by the projection unit.

The warning message 10 may be “CAUTION TOO CLOSE” or some other, similar message. The user may select any one of several warning messages 10 which are stored by the control unit or, optionally, elect to display a series of different warning messages 10 which alternate on display, increasing visibility for the driver of the following vehicle. Preferably, the color of the displayed warning message 10 is red, or some other bright color.

If the following vehicle continues to tailgate for a predetermined period such as 2 seconds or more, the camera or the photoelectric sensors 10 may acquire an image of the following vehicle's license plate, and transmit the image to the control unit. The image, along with date, time, speed, distance, and location information which is acquired from GPS, is then transmitted to the user's auto insurance company for further action. Such further action may include a warning letter to the driver of the following vehicle, or to the driver's auto insurance company.

Optionally, the invention may further provide a series of business methods, processes, and results that solicit cooperative agreements between auto insurance companies, law enforcement agencies, and other entities, to share the information acquired by multiple installations of the invention for the purpose of preventing rear-end collisions.

To use the first exemplary embodiment, the user installs and synchronizes the control unit, the camera, the photoelectric sensors 10, and the projection unit. Further operation of the system is automatic.

Electronic components of the system preferably include a microprocessor, a memory device, a camera, a transmitter capable of operating on Bluetooth™ or a similar medium-range communications protocol, and one or more photoelectric sensors 10.

The control unit, the camera, the photoelectric sensors 10, and the projection unit are preferably manufactured from rigid, durable materials, such as plastic, steel, copper alloy, brass, and aluminum alloy. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A warning message system for deterrence of tailgating, comprised of a control unit which provides electronic communication with the control system of the user's vehicle, a camera, one or more photoelectric sensors, and a projection unit.

2. The message system of claim 1, wherein preferably, the camera and the projection unit are to be installed on the rear deck of the passenger compartment of the vehicle, beneath the rear window, and the photoelectric sensors are to be installed on the rear bumper of the vehicle.

3. The message system of claim 1, wherein preferably, the control unit draws electric power from the electric system of the user's vehicle.

4. The message system of claim 1, wherein the photoelectric sensors determine the distance between the user's vehicle and any vehicle which may be following, then the system compares this distance to the speed of the user's vehicle, acquired from the speedometer, to determine whether the driver of the following vehicle is allowing a safe stopping distance between vehicles.

5. The message system of claim 1, wherein if it is determined that the driver of the following vehicle is tailgating, a large warning message such as “CAUTION TOO CLOSE” is projected on the rear window of the user's vehicle by the projection unit.

6. The message system of claim 1, wherein the user may select any one of several warning messages which are stored by the control unit or, optionally, elect to display a series of different warning messages which alternate on display, increasing visibility for the driver of the following vehicle.

7. The message system of claim 1, wherein preferably, the color of the displayed warning message 10 is red, or some other bright color.

8. The message system of claim 1, wherein if the following vehicle continues to tailgate for a predetermined period such as 2 seconds or more, the camera or the photoelectric sensors may acquire an image of the following vehicle's license plate, and transmit the image to the control unit.

9. The message system of claim 1, wherein the image, along with date, time, speed, distance, and location information which is acquired from GPS, is then transmitted to the user's auto insurance company for further action, such as a warning letter to the driver of the following vehicle, or to the driver's auto insurance company.

10. The message system of claim 1, wherein optionally, the invention may further provide a series of business methods, processes, and results that solicit cooperative agreements between auto insurance companies, law enforcement agencies, and other entities, to share the information acquired by multiple installations of the invention for the purpose of preventing rear-end collisions.

11. The message system of claim 1, wherein the electronic components of the system preferably include a microprocessor, a memory device, a camera, a transmitter capable of operating on Bluetooth™ or a similar medium-range communications protocol, and one or more photoelectric sensors.

12. The message system of claim 1, wherein the control unit, the camera, the photoelectric sensors, and the projection unit are preferably manufactured from rigid, durable materials, such as plastic, steel, copper alloy, brass, and aluminum alloy.
